(19) United States
(12) Patent Application Publication
(10) Pub. No.: US 2022/0171757 A1
(43) Pub. Date: Jun. 2, 2022

(54) COMMUNICATIONS DEVICE, METHOD AND COMMUNICATIONS SYSTEM FOR MANAGING A PLURALITY OF DATA STRUCTURES

(71) Applicant: GRABTAXI HOLDINGS PTE. LTD., Singapore (SG)

(72) Inventors: Yogesh MADAAN, Singapore (SG); Yongkai TEO, Singapore (SG)

(21) Appl. No.: 17/436,923

(22) PCT Filed: Mar. 21, 2019
(86) PCT No.: PCT/SG2019/050153

§ 371 Date: Sep. 7, 2021

(51) Int. Cl. G06F 16/23; G06Q 50/30

(52) U.S. Cl. CPC G06F 16/2322; G06Q 50/30; G06F 16/2365

(57) ABSTRACT

A communications device for managing a plurality of data structures, which is configured to observe a data stream for changes, the data stream having a plurality of data structures, each having an associated timestamp and data corresponding to a request relating to a job, filter, sequentially based on the associated timestamps, the data structures associated with requests causing the changes, wherein, for filtering, the communications device is configured, for each data structure, to query a database, if data corresponding to the job is in the database, determine, from the data corresponding to the job, a status of the job, and determine, based on the status and the data of the data structure, whether the data of the data structure is valid data, and if there is no data corresponding to the job in the database, determine the data of the data structure as valid data, and process the valid data.

### TECHNICAL FIELD

The invention relates generally to the field of communications. One aspect of the invention relates to a communications device for managing a plurality of data structures. Other aspects of the invention relate to a method for managing a plurality of data structures, and a communications system for managing a plurality of data structures.

One aspect of the invention has particular, but not exclusive, application to managing a plurality of data structures relating to transport-related services, for example, ride-hailing transportation services.

### BACKGROUND

The current state of art exposes direct accesses to a database which makes it very difficult to have an access control as there may be multiple components or channels trying to access the database at the same time. Consequently, a UI (user interface) layer accessing the database can cause race conditions due to multiple components accessing it.

Also, activity containing business logic is comparatively difficult to test activity code in Android due to the dependency of android runtime lifecycle in activities.

### SUMMARY

Aspects of the invention are as set out in the independent claims. Some optional features are defined in the dependent claims.

Implementation of the techniques disclosed herein may provide significant technical advantages. These may include a data stream having data structures that are transmitted from a communications server apparatus already with the associated timestamps. The data stream may be observed for any changes in the state of the data stream. Subsequently, at least some of the data structures may be processed/filtered based on the associated timestamps and status of jobs.

In at least some implementations, the techniques disclosed herein may enable querying and updating a database, and reading from a database to be carried out via a single access point or component. In at least some other implementations, querying and updating a database may be carried out via one access point or component, while reading from a database may be carried out via another access point or component.

In at least some implementations, the techniques disclosed herein allow for better control over accesses to a database as processing of data structures may be carried out in the order of the associated timestamps. Accordingly, risks of undesirable race conditions may be minimised. Effectively, the techniques may control sequential access to the database, to stop multiple threads writing to the database simultaneously that may otherwise compromise the integrity of the data in the database. Further, there may be better efficiency and faster processing as filtering may be carried out based on the status of jobs to identify data structures that may be valid for further processing.

In an exemplary implementation, the functionality of the techniques disclosed herein may be implemented in software running on a handheld communications device, such as a mobile phone. The software which implements the functionality of the techniques disclosed herein may be contained in an “app”—a computer program, or computer program product—which the user has downloaded from an online store. When running on the, for example, user's mobile telephone, the hardware features of the mobile telephone may be used to implement the functionality described below, such as using the mobile telephone's transceiver components to establish the secure communications channel for managing a plurality of data structures.

### BRIEF DESCRIPTION OF THE DRAWINGS

The invention will now be described, by way of example only, and with reference to the accompanying drawings in which:

FIG. 1 is a schematic block diagram illustrating an exemplary communications system involving a communications server apparatus.

FIG. 2A shows a schematic block diagram illustrating a communications device for managing a plurality of data structures.

FIG. 2B shows a flow chart illustrating a method performed in a communications device for managing a plurality of data structures.

FIGS. 3A to 3C show flow charts illustrating the techniques for managing a plurality of data structures.

### DETAILED DESCRIPTION

Various embodiments may relate to re-architecting job transit screens for a scalable future.

The present techniques may implement access control over accessing a jobs database. As will be described further below, in some embodiments, the Display job dispatcher may be the only component that may write on/to the database on receiving events from a (data) stream. It may handle the responsibility of filtering requests based on timestamps to maintain a sequential handling of the events. It may also expose API (application programming interface) to access active jobs which are consumed by UI (user interface) to have a unified data flow in the application.

In at least some implementations, there may be provided access control over accessing a database by routing all requests through a “Display Job Dispatcher” and smartly handling all filtering logic at a common place.

The UI layer for the techniques disclosed herein may be based on MVVM (Model-View-ViewModel) pattern and an activity may (just) use 12 different view models. Each of these view models may be aware of activity lifecycle and may have no information about other view models which make this an independent and decoupled system. This helps to add features for any of them without impacting the other, the process/system to move faster. The view models have been fully tested and may be employed in various disclosed techniques.

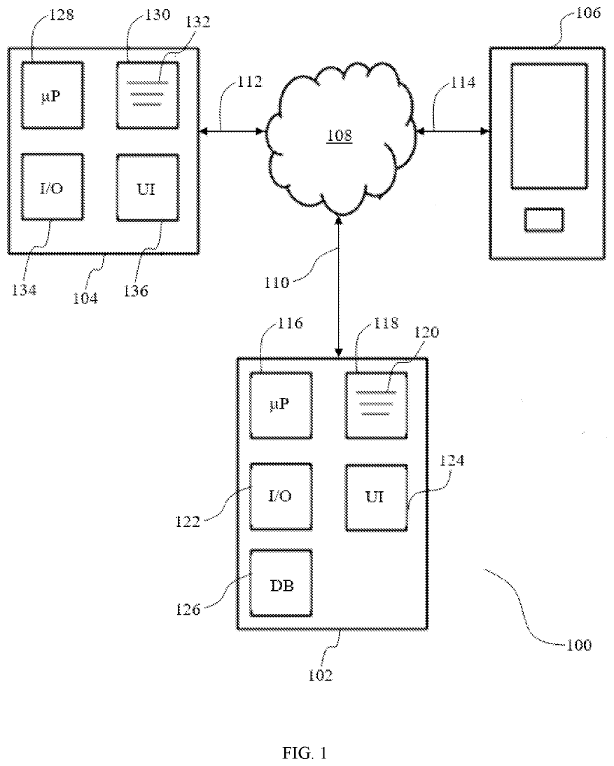

Referring first to FIG. 1, a communications system 100 is illustrated, which may be applicable in various embodiments. The communications system 100 includes a communications server apparatus 102, a first user (or client) communications device 104 and a second user (or client) communications device 106. These devices 102, 104, 106 are connected in or to the communications network 108 (for example, the Internet) through respective communications links 110, 112, 114 implementing, for example, internet communications protocols. The communications devices 104, 106 may be able to communicate through other communications networks, such as public switched telephone networks (PSTN networks), including mobile cellular communications networks, but these are omitted from FIG. 1 for the sake of clarity. It should be appreciated that there may be one or more other communications devices similar to the devices 104, 106.

The communications system 100 may be for managing a plurality of data structures.

The communications server apparatus 102 may be a single server as illustrated schematically in FIG. 1, or have the functionality performed by the communications server apparatus 102 distributed across multiple server components. In the example of FIG. 1, the communications server apparatus 102 may include a number of individual components including, but not limited to, one or more microprocessors (μP) 116, a memory 118 (e.g., a volatile memory such as a RAM (random access memory)) for the loading of executable instructions 120, the executable instructions 120 defining the functionality the server apparatus 102 carries out under control of the processor 116. The communications server apparatus 102 may also include an input/output (I/O) module 122 allowing the server apparatus 102 to communicate over the communications network 108. User interface (UI) 124 is provided for user control and may include, for example, one or more computing peripheral devices such as display monitors, computer keyboards and the like. The communications server apparatus 102 may also include a database (DB) 126, the purpose of which will become readily apparent from the following discussion.

The communications server apparatus 102 may be for transmitting a data stream having a plurality of data structures.

The user communications device 104 may include a number of individual components including, but not limited to, one or more microprocessors (μP) 128, a memory 130 (e.g., a volatile memory such as a RAM) for the loading of executable instructions 132, the executable instructions 132 defining the functionality the user communications device 104 carries out under control of the processor 128. User communications device 104 also includes an input/output (I/O) module 134 allowing the user communications device 104 to communicate over the communications network 108. A user interface (UI) 136 is provided for user control. If the user communications device 104 is, say, a smart phone or tablet device, the user interface 136 may have a touch panel display as is prevalent in many smart phone and other handheld devices. Alternatively, if the user communications device 104 is, say, a portable computer or laptop computer, the user interface may have, for example, one or more computing peripheral devices such as display monitors, computer keyboards and the like.

The user communications device 106 may be, for example, a smart phone or tablet device with the same or a similar hardware architecture to that of the user communications device 104.

The user communications device 104 and/or the user communications device 106 may be for managing a plurality of data structures.

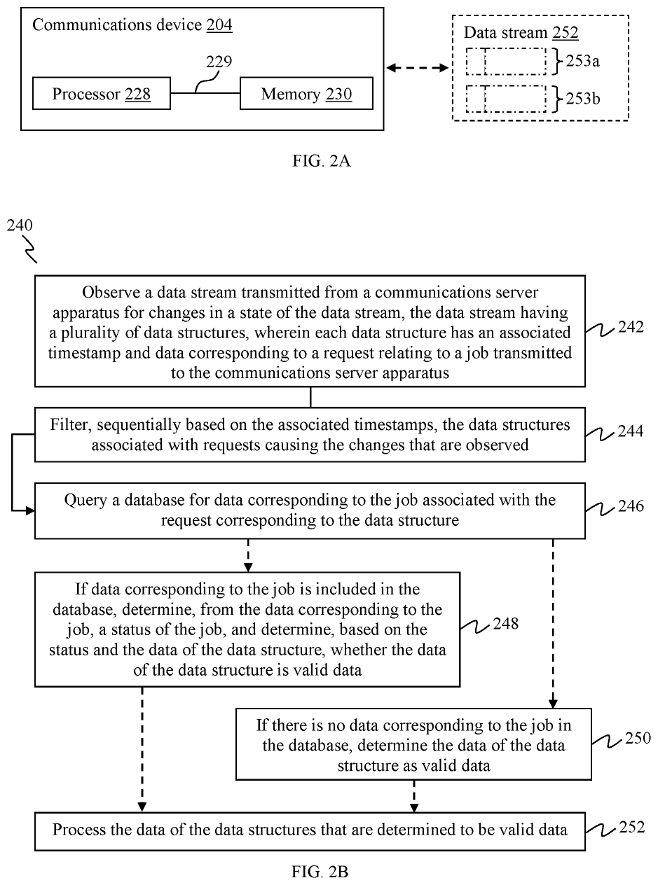

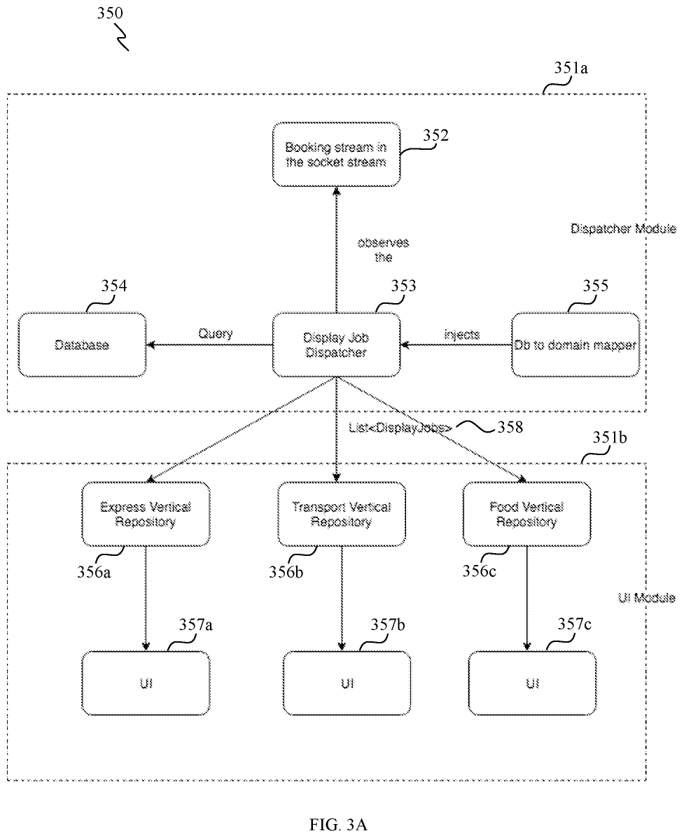

FIG. 2A shows a schematic block diagram illustrating a communications device 204 for managing a plurality of data structures. The communications device 204 includes a processor 228 and a memory 230, where the communications device 204 is configured, under control of the processor 228 to execute instructions in the memory 230 to, observe a data stream 252 transmitted from a communications server apparatus for changes in a state of the data stream 252, the data stream 252 having a plurality of data structures (e.g., two data structures 253a, 253b are illustrated), wherein each data structure 253a, 253b has an associated timestamp and data corresponding to a request relating to a job transmitted to the communications server apparatus, filter, sequentially based on the associated timestamps, the data structures (e.g., 253a) associated with requests causing the changes that are observed, wherein, for filtering, the communications device 204 is configured, for each data structure 253a, to query a database for data corresponding to the job associated with the request corresponding to the data structure 253a, if data corresponding to the job is included in the database, determine, from the data corresponding to the job, a status of the job, and determine, based on the status and the data of the data structure 253a, whether the data of the data structure 253a is valid data, and if there is no data corresponding to the job in the database, determine the data of the data structure 253a as valid data, and process the data of the data structures 253a that are determined to be valid data. The processor 228 and the memory 230 may be coupled to each other (as represented by the line 229), e.g., physically coupled and/or electrically coupled. The processor 228 may be as described in the context of the processor 128 (FIG. 1) and/or the memory 230 may be as described in the context of the memory 130 (FIG. 1).

In other words, a (user) communications device 204 may be provided. The communications device 204 may monitor a data stream 252 that may be provided from, or transmitted from/by a communications server apparatus for any changes in the state of the data stream 252. The data stream 252 may include a plurality of data structures 253a, 253b (e.g., two, three, four or any higher number of data structures). Each data structure 253a, 263b may have its own timestamp and may include data or information corresponding to a request relating to a job. The requests may be transmitted to the communications server apparatus. As a non-limiting example, the associated timestamps may be assigned as the requests are received by or at the communications server apparatus.

As non-limiting examples, there may be a change in the state of the data stream 252 due to incorporation/insertion, as part of the data stream 252, of data structures corresponding to new requests or new jobs, or data structures corresponding to changes in the status of one or more jobs (e.g., updates related to the jobs, e.g., cancellation of job, job being assigned to another service provider, etc.).

The communications device 204 may filter (all) the data structures associated with requests causing the changes that are observed, in a sequential order based on the associated timestamps. This may include, for each data structure, the communications device 204 querying a database (e.g., included in the communications device 204) for data corresponding to the job associated with the request corresponding to the data structure. If there are existing data or information corresponding to the job in the database, the communications device 204 may determine, from the data corresponding to the job, a status of the job, and determine, based on the status and the data of the data structure, whether the data of the data structure is valid data.

As a non-limiting example, there may already be a job assigned to or accepted by a service provider. Subsequently, the job may be cancelled by the person requesting the job. In this way, the status of the job in the database and the cancellation request are compatible with each other, and the data of the data structure relating to the cancellation request may be determined to be valid data.

As a further non-limiting example, there may be a new job request. Subsequently, the job request may be cancelled by the person requesting the job, followed by a service provider “accepting” the job request. In this way, the status of the job in the database after the cancellation request and the data of the data structure relating to a service provider “accepting” the job request are in conflict with each other since with the cancellation, there is effectively no job to be accepted by the service provider. As such, the data of the data structure relating to a service provider “accepting” the job request may be determined to be invalid data.

If there is no data corresponding to the job in the database, the communications device 204 may determine the data of the data structure as valid data. This is because, there is no existing job status in the database that may conflict with the data of the data structure. As a non-limiting example, the data of the data structure may correspond to a new job request.

Subsequently, the communications device 204 may process the data of the data structures that are determined to be valid data. This may be carried out sequentially based on the associated timestamps.

For processing the data of the data structures, the communications device 204 may be configured to, for each data structure (e.g., 253a), update the database with data for the associated job based on the valid data.

For processing the data of the data structures, the communications device 204 may be configured to, for each data structure (e.g., 253a), map the valid data into a template that may be presentable (or viewable) via a user interface (UI) of the communications device 204. This provides mapping to a “view” mode for presentation on the communications device to a user/service provider. Effectively, a DB (database) model with raw data, may be mapped into a domain model with view data.

In various embodiments, the job may include or may be a transport-related service. This may include services that deliver one or more items to one or more locations, transportation services for one or more people, etc.

In various embodiments, the transport-related service may include or may be a ride-hailing transportation service. This may include, for example, car-hailing, and (motor)bike-hailing services.

In various embodiments, the transport-related service may include a journey having a pick-up location and at least one destination location. The communications device 204 may be further configured to observe a data source (or data storage) (e.g., observe one or more files in the data source) for data indicating arrival of a service provider at the pick-up location, and update the database with the data indicating arrival at the pick-up location. For example, a service provider (e.g., driver) may send a request “I am here” when reaching or has reached the pick-up location as an update.

In the context of various embodiments, the data source may be a public memory pool or shared memory pool.

In various embodiments, the communications device 204 may be further configured to observe the data source for data indicative of a completion of a pick-up action at the pick-up location, and update the database with the data indicative of the completion of the pick-up action. As a non-limiting example, the data indicative of the completion of the pick-up action may include data representative of an address of the pick-up location. For example, a service provider (e.g., driver) may send, as an update, a request “completed address” when the pick-up action has been fulfilled at the pick-up location, such as when a passenger has been picked up.

In various embodiments, the at least one destination location may include a final destination location at an end of the journey. The communications device 204 may be further configured to transmit a data structure having data corresponding to a request for ending the transport-related service to the communications server apparatus, the data indicating arrival at the final destination location. This data structure may be incorporated into the data stream.

In various embodiments, the at least one destination location may include an intermediate location along the journey towards the final destination location. The communications device 204 may be further configured to observe the data source (e.g., observe one or more files in the data source) for data indicating arrival of the service provider at the intermediate location, and update the database with the data indicating arrival at the intermediate location. For example, a service provider (e.g., driver) may send a request “I am here” when reaching or has reached the intermediate location as an update. A further “completed address” request may also be sent as an update if or when a pick-up action has been completed at the intermediate location. The intermediate location may be for a pick-up (e.g., for one or more additional passengers to get on) and/or a drop-off (e.g., for one or more existing passengers to alight).

In the context of various embodiments, the data source acts as another source of data, in addition to the database.

In the context of various embodiments, the data source may be or may include a Shared Preferences data storage (for Android operating systems or environments), which is a public memory pool.

In various embodiments, there may be multiple destination locations or multiple drop-off locations. Data indicating arrival at the final destination location will be made known to the communications server apparatus, while data indicating arrival at an intermediate location may only be known to the app on the communications device 204.

FIG. 2B shows a flow chart 240 illustrating a method, performed in a communications device for managing a plurality of data structures, and under control of a processor of the communications device.

At 242, a data stream transmitted from a communications server apparatus is observed for changes in a state of the data stream, the data stream having a plurality of data structures, wherein each data structure has an associated timestamp and data corresponding to a request relating to a job transmitted to the communications server apparatus.

At 244, the data structures associated with requests causing the changes that are observed are filtered sequentially based on the associated timestamps.

For filtering at 244, at 246, a database is queried for data corresponding to the job associated with the request corresponding to the data structure. At 248, if data corresponding to the job is included in the database, a status of the job is determined from the data corresponding to the job, and, based on the status and the data of the data structure, it is determined whether the data of the data structure is valid data. At 250, if there is no data corresponding to the job in the database, the data of the data structure is determined as valid data.

At 252, the data of the data structures that are determined to be valid data are processed.

In various embodiments, at 252, for each data structure, the database may be updated with data for the associated job based on the valid data.

In various embodiments, at 252, for each data structure, the valid data may be mapped into a template that may be presentable via a user interface of the communications device.

In various embodiments, the job may include or may be a transport-related service. The transport-related service may include or may be a ride-hailing transportation service.

In various embodiments, the transport-related service may include a journey having a pick-up location and at least one destination location, and the method may further include observing a data source (or data storage) for data indicating arrival of a service provider at the pick-up location, and updating the database with the data indicating arrival at the pick-up location.

In various embodiments, the method may further include observing the data source for data indicative of a completion of a pick-up action at the pick-up location, and updating the database with the data indicative of the completion of the pick-up action.

In various embodiments, the at least one destination location may include a final destination location at an end of the journey, and the method may further include transmitting a data structure having data corresponding to a request for ending the transport-related service to the communications server apparatus, the data indicating arrival at the final destination location.

In various embodiments, the at least one destination location may include an intermediate location along the journey towards the final destination location, and the method may further include observing the data source (or data storage) for data indicating arrival of the service provider at the intermediate location, and updating the database with the data indicating arrival at the intermediate location.

It should be appreciated that descriptions in the context of the communications device 204 may correspondingly be applicable in relation to the method as described in the context of the flow chart 240, and vice versa.

In the context of various embodiments, a (user) communications device may include, but not limited to, a smart phone, tablet, handheld/portable communications device, portable or laptop computer, etc.

In the context of various embodiments, an “app” or an “application” may be installed on a (user) communications device and may include processor-executable instructions for execution on the device. As a non-limiting example, at least some requests relating to jobs may be transmitted via an app.

There may also be provided a computer program product having instructions for implementing a method for managing a plurality of data structures as described herein.

There may also be provided a computer program having instructions for implementing a method for managing a plurality of data structures as described herein.

There may further be provided a non-transitory storage medium storing instructions, which, when executed by a processor, cause the processor to perform a method for managing a plurality of data structures as described herein.

Various embodiments may further provide a communications system for managing a plurality of data structures, having a communications server apparatus, at least one user communications device and communications network equipment operable for the communications server apparatus and the at least one user communications device to establish communication with each other therethrough, wherein the communications server apparatus includes a first processor and a first memory, the communications server apparatus being configured, under control of the first processor, to execute first instructions in the first memory to transmit a data stream having a plurality of data structures, wherein each data structure has an associated timestamp and data corresponding to a request relating to a job transmitted to the communications server apparatus, wherein the at least one user communications device includes a second processor and a second memory, the at least one user communications device being configured, under control of the second processor, to execute second instructions in the second memory to observe the data stream transmitted from the communications server apparatus for changes in a state of the data stream, filter, sequentially based on the associated timestamps, the data structures associated with requests causing the changes that are observed, wherein, for filtering, the communications device is configured, for each data structure, to query a database for data corresponding to the job associated with the request corresponding to the data structure, if data corresponding to the job is included in the database, determine, from the data corresponding to the job, a status of the job; and determine, based on the status and the data of the data structure, whether the data of the data structure is valid data, and if there is no data corresponding to the job in the database, determine the data of the data structure as valid data, and process the data of the data structures that are determined to be valid data.

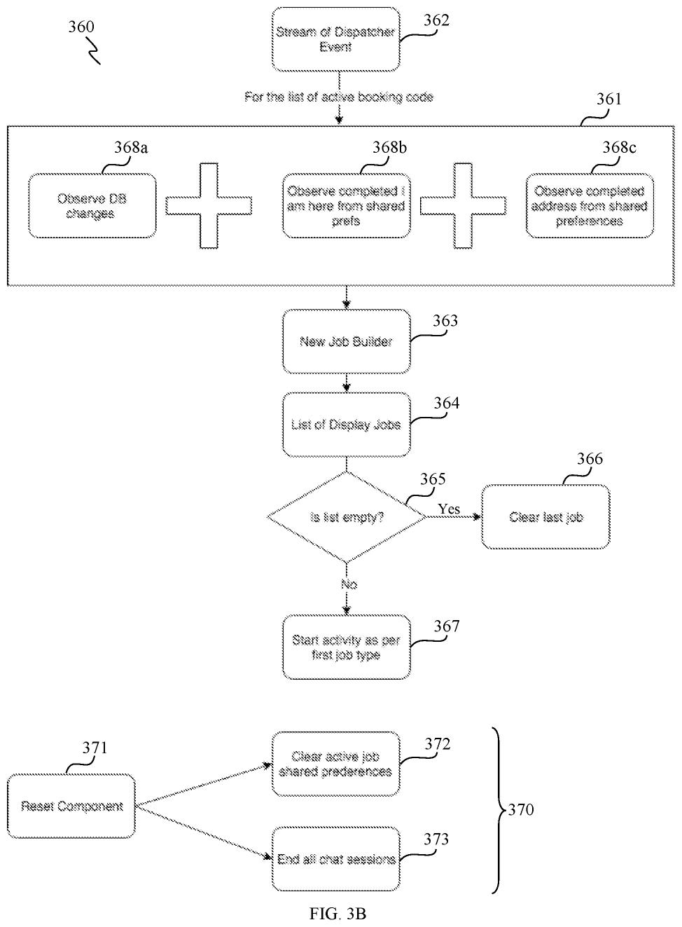

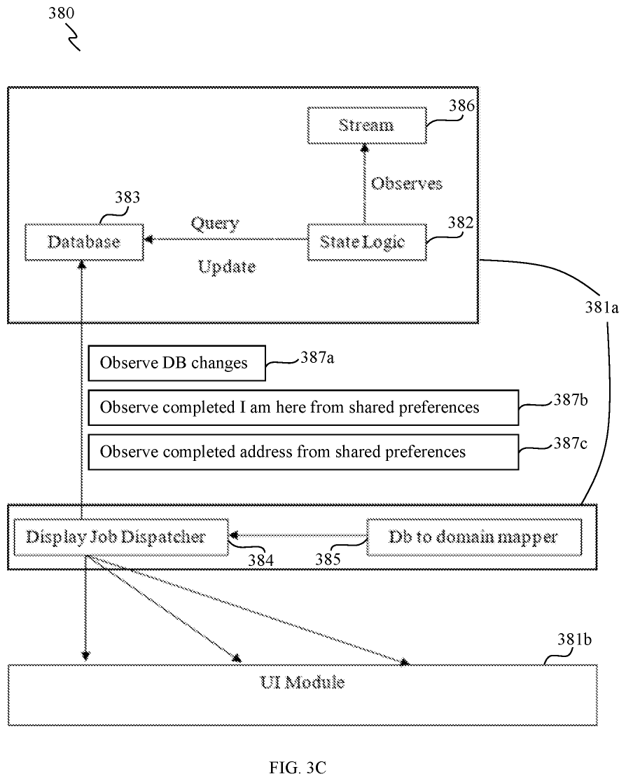

Various embodiments or techniques will now be further described in detail by way of the following non-limiting examples and with reference to FIGS. 3A to 3C showing flow charts 350, 360, 380 illustrating the techniques for managing a plurality of data structures.

Known designs were based on MVP (Model-View-Presenter) pattern and consist of a set of API for both views and the presenter (which acts upon the model and the view). With time, the number of these API was increasing and around 50 API were reached to define the contracts between the view and the presenter. Also, for example, “activity” (in an Android environment), defined as a stateful view which has the knowledge of when the view is created/destroyed/shown or hidden, had knowledge of components like driver availability as availability depends on activity lifecycle, thereby, making a very tightly coupled system.

The techniques disclosed herein may rely on using a repository pattern to expose independent CRUD (create, read, update, and delete) access layers to a database (DB) and exposes a Domain Entity (DisplayJob) to be consumed by UI components.

Referring to FIG. 3A, there is shown a Dispatcher Module 351a and a UI (user interface) Module 351b in the flow chart 350. Within the Dispatcher Module 351a are shown blocks representing a data stream (in the form of a booking stream (or job stream) 352), a “Display Job Dispatcher” 353, a database 354, a “Db (Database) to domain mapper” 355.

There may be one or more vertical depositories within the UI Module 351b. As non-limiting examples, three vertical depositories are illustrated, in the form of an “Express Vertical Depository” 356a, a “Transport Vertical Depository” 356b, and a “Food Vertical Depository” 356c. Each of these vertical depositories 356a, 356b, 356c has an associated UI 357a, 357b, 357c.

The main role of the “Display Job Dispatcher” component 353 is to keep on observing the live TCP (Transmission Control Protocol) socket for data stream 352 for any changes in the state of the data stream 352, and also changes in the database 354. At least some changes in the database 354 may result from the changes in the data stream 352. For example, the database 354 may be updated as a consequent of a change in the data stream 352. The output from the “Display Job Dispatcher” component 353 is a stream of a list of display jobs 358 which will keep on updating whenever there is a change in any of the data stream 352 and/or the database 354. For example, a change may occur in respective data flows for (i) any new job that may be assigned to a service provider (e.g., driver); (ii) any state change such as dropping off to an existing job to the service provider (e.g., driver).

The data stream or booking stream 352 is a stream of data from a back-end service (e.g., communications server apparatus) which may then be provided to user or service provider's app in a communications device. The stream may include a plurality of data structures, each having an associated timestamp and data relating to a job or a request corresponding to the job. The data may include a job ID. The data may relate to job booking, job updating, incentives, etc. The data may contain type and payload, where type may be integers, e.g., 204, 209, etc., while payload may be some string containing or representative of job information.

Here, the “Display Job Dispatcher” 353 is the only component that may observe, query, read, and update the database 354.

The stateless utility component “Db to Domain Mapper” 355 takes the list of DB jobs and converts them to a list of domain jobs, called “Display Jobs” in order to achieve a dumb UI without any logic. This also helps to concentrate all mapper logic at a single place. The “Db to Domain Mapper” 355 maps the DB jobs into a form or template that may be presentable or viewable via the UI module 351b for viewing by a user. Effectively, the “Db to Domain Mapper” 355 may convert database data to a format for display on a communications device's UI.

The three different specific vertical repositories, namely Transport 356b, Food 356c and Express 356a may require different handling for specific events like clicking a “I have arrived” button. Each repository 356a, 356b, 356c may involve one or more sets of API. In order to abstract this responsibility from the UI 357a, 357b, 357c, state handlers have been designed, which depend on the dispatcher 353 for the list of active jobs 358 and provide additional API's based on their vertical requirements. Non-limiting examples of additional APIs may include
makeDriverAvailableAsPerCurrentJob( ), and/or
UpdateBackendWhenDriverInteractWithMap( ).

Each UI 357a, 357b, 357c is a stateless component in terms of data manipulation. This mainly include view models which are being observed by the view as per the guidelines of “Data Binding” (https://developer.android.com/topic/libraries/data-binding/) and its (only) responsibility is to get the data and display it. UI may only require the dependency of their specific vertical repositories, e.g., 356a, 356b, 356c, in order to be aware of the active jobs.

The techniques disclosed herein will now be described in more detail in the context of some implementations, for example, in the context of ride-hailing transportation services, with reference to FIG. 3B. In the flow chart 360, there is shown a “Display Job Dispatcher” 361 which may observe a data stream 362. The “Display Job Dispatcher” 361 may also observe at least one of database (DB) changes 368a, which may result from changes in the data stream 362, data related to “completed I am here” 368b or data related to “completed address” 368c from the Shared Preferences data storage associated with the corresponding communications device.

The data related to “completed I am here” 368b may be related to arrival of a service provider at a pick-up location. For example, a service provider such as a driver may provide an update of “completed I am here” (e.g., via click or activation through the app), which may cause a change in the state of the job in the system, for example, changing the state from “Reaching Location” to “Waiting for Passenger”.

The data related to “completed address” 368c may be related to completion of a pick-up action at the pick-up location. For example, a service provider such as a driver may provide an update of “completed address” (e.g., via click or activation through the app) to provide data indicative of the completion of the pick-up action at the pick-up location such as an address or position of the passenger(s) who has been already picked up at the pick-up location by a driver in a particular booking or job.

Following from these observations, a “New Job Builder” 363 (“New Job Builder” is the name given in code for DB To Domain Mapper) may suitably generate a list 364 which may contain display or active jobs. The list 364 is determined at 365 as to whether it is empty or not. If the list 364 is empty, at 366, the last job is cleared. The “last job” is generally stored in memory for calculation purpose, and, as soon as this job is completed, it is cleared from the memory. If the list 364 is not empty, and contains active jobs, “activity” may be started at 367 per the first job type. An “activity” is a single, focused thing that a user or service provider can do. Further, a service provider (e.g., a driver) may have more than one job, for example, one job relating to transport and another job relating to food. The “first job type” is defined by the type of job the service provider is having at position one in the list of jobs.

As may be described further below in relation to FIG. 3C, a corresponding UI may call a Vertical Depository and the Vertical Depository may call the “Display Job Dispatcher” 361.

There may be included a reset process 370, which may be initiated by the backend when the backend informs that there are no jobs active for the service provider (e.g., driver), and everything is reset, clearing all the data saved in the memory like the “last job”. The reset process 370 may include resetting of the various components 371 (e.g., “Display Job Dispatcher” 361, “New Job Builder” 363, etc.), which subsequently result in clearing of the active job shared preferences 372 and/or ending of all chat sessions 373. Generally, a job may be associated with a chat session which allows a service provider (e.g., driver) to contact the person requesting the job (e.g., passenger) using chat messages.

It should be appreciated that some components are not shown in FIG. 3B for brevity but may nevertheless be provided, which may be similar to components described in the context of FIG. 3A.

In some implementations, referring to the flow chart 380 of FIG. 3C, an additional “State logic” 382 may be provided in a Dispatcher Module 381a, which may also include a database 383, a “Display Job Dispatcher” 384 and a “Db to Domain Mapper” 385. The “State logic” 382 may carry out similar functions as those for the “Display Job Dispatcher” 353 (FIG. 3A), e.g., to observe a data or booking stream 386, to query the database 383 and to update the database 383. The data stream 386 and/or the database 383 may be as described in the context of FIG. 3A.

In the implementations in the context of the flow chart 380, the “Display Job Dispatcher” 384 may observe the database 384 for any database changes 387a, and/or the Shared Preferences data storage associated with the corresponding communications device for at least one of data related to “completed I am here” 387b or data related to “completed address” 387c, as may be described in the context of FIG. 3B.

The “Display Job Dispatcher” 384 may receive output from a “Db to domain mapper” 385 which may be as described in the context of FIG. 3A. The “Display Job Dispatcher” 384 may further provide a list of display jobs through the corresponding vertical depositories and UI in the UI Module 381b as may be described in the context of FIG. 3A.

In the implementations in the context of FIG. 3C, the “Display Job Dispatcher” 384 is the only component that reads from the database 383. Further, updating of the database 383 is now delegated to the “State Logic” 382.

In various implementations of the techniques, the data stream may be intended for an individual or single user or service provider (e.g., a driver), where the communications device of the service provider may be used to observe the data stream. The “Display job dispatcher” as described herein may be resident in the service provider's app on the service provider's communications device. The techniques may allow looking for changes in data relating to a job, e.g., new jobs, changes in jobs and so on. Filtering may be carried out by job ID. Further, the techniques may allow observing database changes and/or observing the stream buffer in the service provider's phone/app. In the techniques disclosed herein, querying may be carried out to determine whether a job is a valid job, and if so, updating of the database may be carried out for the new state of the job.

As described above, in order to address one or more problems associated with the current art, there are provided techniques for implementing access control over a database, and for making changes to the database, by controlling multiple access to the database. The techniques may provide a “Display job dispatcher”, which may be the only component that reads from the database, and writes to the database on receiving events from a (data) stream. It handles the responsibility of filtering requests based on timestamps to maintain a sequential handling of events. The “Display job dispatcher” may be defined by a set of instructions resident in the app on a user's communications device.

The “Display job dispatcher” may look out for a job/booking stream from a server. When the “Display job dispatcher” observes any state change in the job stream (e.g., new jobs, changes in job status, etc.), it may query a database and determine whether a job is valid based on the existing status that may be recorded/present in the database for said job. Details relating to the job may also be updated in the database. Where the job is determined to be valid, a “Db to domain mapper” may then convert the database data to UI model for display to a user on the UI (user interface) of a communications device via a corresponding app. A list of display jobs may then be relayed via the corresponding vertical repository (API) to the UI for the user to see the jobs and to decide whether to accept a job. The list of display jobs may be updated whenever there is an update to the booking stream and/or database. A user may also provide update via the UI of a corresponding app on the user's communications device, which may then be sent to the server. The “Display job dispatcher” may then pick up the update/change and query/update the database. As such, all data, changes to a database, etc., may be routed through a single component “Display job dispatcher”.

Alternatively, as also described above, an additional “State logic” may be provided that does the same function described above for the “Display Job Dispatcher”, i.e., to observe the booking stream, to query the database and update the database. In such a technique, the “Display Job Dispatcher” may then observe the database for any changes to the database, and, further, may receive output from the “Db to domain mapper” and may provide a list of display jobs through the corresponding vertical depositories. In this implementation, the “Display Job Dispatcher” may be the only component that reads from the database. Further, updating of the database may now be delegated to the “State Logic”.

The techniques disclosed herein may be implemented in the context of ride-hailing services, where the “Display Job Dispatcher” may receive booking streams from a server and present jobs to a driver via the driver's UI of the corresponding app. In turn, the driver can also provide updates via the UI (e.g., having reached a particular destination or drop-off point) which may then be transmitted back to the “Display Job Dispatcher” via the server for updating of the database.

It should be appreciated that the techniques disclosed herein may be carried out using a communications device with the help of an “app” installed in the communications device. As non-limiting examples, requests relating to a job may be provided or sent via the app. Active jobs may be displayed via the app or a UI of the app.

It will be appreciated that the invention has been described by way of example only. Various modifications may be made to the techniques described herein without departing from the spirit and scope of the appended claims. The disclosed techniques comprise techniques which may be provided in a stand-alone manner, or in combination with one another. Therefore, features described with respect to one technique may also be presented in combination with another technique.

1. A communications device for managing a plurality of data structures, comprising a processor and a memory, the communications device being configured, under control of the processor, to execute instructions in the memory to:
observe a data stream transmitted from a communications server apparatus for changes in a state of the data stream, the data stream comprising a plurality of data structures, wherein each data structure has an associated timestamp and data corresponding to a request relating to a job transmitted to the communications server apparatus;
filter, sequentially based on the associated timestamps, the data structures associated with requests causing the changes that are observed,
wherein, for filtering, the communications device is configured, for each data structure, to:
query a database for data corresponding to the job associated with the request corresponding to the data structure;
if data corresponding to the job is comprised in the database,
determine, from the data corresponding to the job, a status of the job; and
determine, based on the status and the data of the data structure, whether the data of the data structure is valid data; and
if there is no data corresponding to the job in the database, determine the data of the data structure as valid data; and
process the data of the data structures that are determined to be valid data.

2. The communications device as claimed in claim 1, wherein, for processing the data of the data structures, the communications device is configured to, for each data structure, update the database with data for the associated job based on the valid data.

3. The communications device as claimed in claim 1, wherein, for processing the data of the data structures, the communications device is configured to, for each data structure, map the valid data into a template that is presentable via a user interface of the communications device.

4. The communications device as claimed in claim 1, wherein the job comprises a transport-related service.

5. The communications device as claimed in claim 4, wherein the transport-related service comprises a ride-hailing transportation service.

6. The communications device as claimed in claim 4,
wherein the transport-related service comprises a journey comprising a pick-up location and at least one destination location, and
wherein the communications device is further configured to:
observe a data source for data indicating arrival of a service provider at the pick-up location; and
update the database with the data indicating arrival at the pick-up location.

7. The communications device as claimed in claim 6,
wherein the communications device is further configured to:
observe the data source for data indicative of a completion of a pick-up action at the pick-up location; and
update the database with the data indicative of the completion of the pick-up action.

8. The communications device as claimed in claim 6,
wherein the at least one destination location comprises a final destination location at an end of the journey, and
wherein the communications device is further configured to:
transmit a data structure having data corresponding to a request for ending the transport-related service to the communications server apparatus, the data indicating arrival at the final destination location.

9. The communications device as claimed in claim 8,
wherein the at least one destination location comprises an intermediate location along the journey towards the final destination location, and
wherein the communications device is further configured to:
observe the data source for data indicating arrival of the service provider at the intermediate location; and
update the database with the data indicating arrival at the intermediate location.

10. A method, performed in a communications device for managing a plurality of data structures, the method comprising, under control of a processor of the communications device:
observing a data stream transmitted from a communications server apparatus for changes in a state of the data stream, the data stream comprising a plurality of data structures, wherein each data structure has an associated timestamp and data corresponding to a request relating to a job transmitted to the communications server apparatus;
filtering, sequentially based on the associated timestamps, the data structures associated with requests causing the changes that are observed,
wherein filtering, for each data structure, comprises:
querying a database for data corresponding to the job associated with the request corresponding to the data structure;
if data corresponding to the job is comprised in the database,
determining, from the data corresponding to the job, a status of the job; and
determining, based on the status and the data of the data structure, whether the data of the data structure is valid data; and
if there is no data corresponding to the job in the database, determining the data of the data structure as valid data; and
processing the data of the data structures that are determined to be valid data.

11. The method as claimed in claim 10, wherein processing the data of the data structures comprises, for each data structure, updating the database with data for the associated job based on the valid data.

12. The method as claimed in claim 10, wherein processing the data of the data structures comprises, for each data structure, mapping the valid data into a template that is presentable via a user interface of the communications device.

13. The method as claimed in claim 10, wherein the job comprises a transport-related service.

14. (canceled)

15. The method as claimed in claim 13,
wherein the transport-related service comprises a journey comprising a pick-up location and at least one destination location,
the method further comprising:
observing a data source for data indicating arrival of a service provider at the pick-up location; and
updating the database with the data indicating arrival at the pick-up location.

16. The method as claimed in claim 15, further comprising:
observing the data source for data indicative of a completion of a pick-up action at the pick-up location; and
updating the database with the data indicative of the completion of the pick-up action.

17. The method as claimed in claim 15,
wherein the at least destination location comprises a final destination location at an end of the journey,
the method further comprising:
transmitting a data structure having data corresponding to a request for ending the transport-related service to the communications server apparatus, the data indicating arrival at the final destination location.

18. The method as claimed in claim 17,
wherein the at least one destination location comprises an intermediate location along the journey towards the final destination location,
the method further comprising:
observing the data source for data indicating arrival of the service provider at the intermediate location; and
updating the database with the data indicating arrival at the intermediate location.

19. A computer program or a computer program product comprising instructions for implementing the method as claimed in claim 10.

20. A non-transitory storage medium storing instructions, which when executed by a processor cause the processor to perform the method as claimed in claim 10.

21. A communications system for managing a plurality of data structures, comprising a communications server apparatus, at least one user communications device and communications network equipment operable for the communications server apparatus and the at least one user communications device to establish communication with each other therethrough,
wherein the communications server apparatus comprises a first processor and a first memory, the communications server apparatus being configured, under control of the first processor, to execute first instructions in the first memory to:
transmit a data stream comprising a plurality of data structures, wherein each data structure has an associated timestamp and data corresponding to a request relating to a job transmitted to the communications server apparatus;
wherein the at least one user communications device comprises a second processor and a second memory, the at least one user communications device being configured, under control of the second processor, to execute second instructions in the second memory to:
observe the data stream transmitted from the communications server apparatus for changes in a state of the data stream;
filter, sequentially based on the associated timestamps, the data structures associated with requests causing the changes that are observed,
wherein, for filtering, the communications device is configured, for each data structure, to:
query a database for data corresponding to the job associated with the request corresponding to the data structure;
if data corresponding to the job is comprised in the database,
determine, from the data corresponding to the job, a status of the job; and
determine, based on the status and the data of the data structure, whether the data of the data structure is valid data; and
if there is no data corresponding to the job in the database, determine the data of the data structure as valid data; and
process the data of the data structures that are determined to be valid data.
